(19) United States
(12) Patent Application Publication
(10) Pub. No.: US 2015/0343841 A1
(43) Pub. Date: Dec. 3, 2015

(54) WHEEL HUB ROLLING BEARING UNIT WITH A SIGNAL EMITTER ON A HIGHER AREA OF AN INNER RING WITHIN A SEALING CAP HAVING A PROTRUSION FOR SECURING A SENSOR

(71) Applicant: SCHAEFFLER TECHNOLOGIES GMBH & CO. KG, Herzogenaurach (DE)

(72) Inventors: Andreas Kaiser, Werneck (DE); Roland Langer, Schwanfeld (DE); Ralf Heiss, Schweinfurt (DE); Christian Mock, Schweinfurt (DE); Jonas Lang, Schwebheim (DE); Frank Eichelmann, Hassfurt (DE)

(73) Assignee: Schaeffler Technologies AG & Co. KG, Herzogenaurach (DE)

(21) Appl. No.: 14/652,570

(22) PCT Filed: Oct. 28, 2013
(86) PCT No.: PCT/DE2013/200256

§ 371 Date: Jun. 16, 2015

(30) Foreign Application Priority Data
Dec. 20, 2012 (DE) 10 2012 223 881.6

(51) Int. Cl. B60B 27/00

(52) U.S. Cl. CPC B60B 27/0078; B60B 27/0005; B60B 27/0068; B60B 27/0073; B60B 2380/12; B60B 2380/73

(57) ABSTRACT

A roller riveting assembled hub bearing unit, the inner ring (2) of which has a radially elevated region for resolving production problems during the roller riveting process. For such a hub bearing unit, an optimal sensor arrangement, such as that required for rotational speed detection for example, is to be provided without having to accept disadvantages with rotational speed detection, sealing and strength optimization of the inner ring (2). A signal emitter (5) is arranged axially flush in a flat manner on the side of the vehicle on a higher area of the inner ring (2). A cover (8) axially covers the wheel hub (18) on the vehicle side. The detection of the movement of the signal emitter (5) takes place in the axial direction through the cover (8). To accommodate the sensor, the cover (8) comprises a protrusion (15) which is axially opposite the signal emitter (5), which can be arranged radially within the outer ring (3) either partially or completely. An axially short design, which additionally implies a protected sensor in a cover (8), is provided.

### BACKGROUND

The invention relates to a wheel bearing unit with an inner ring that can rotate together with a wheel hub, wherein the inner ring is mounted by means of a rolled rivet on the wheel hub, in order to pretension a row of rolling bodies relative to an outer ring, wherein a raised area of the inner ring adjacent to the rolled rivet flange is raised radially above an outer rolling body raceway of the inner ring.

Roller riveted wheel bearing units have been used in a large number of variants in the past for passenger cars. They are regularly used even in non-driven wheel bearing units in connection vehicle-side covers that can assume a large part of the axial-side sealing function. Even in connection with wheel bearing units that can detect or measure, for example, wheel rotational speeds using sensors, these cover closures are advantageous because an opening of the cover or a sensor recess that must be sealed is not required to measure the rotational speed through the cover. Covers with mounted sensors are made, at least in the sensor area, from a magnetically permeable material, which is why stainless steel covers are often used.

Due to the roller riveting process, the mentioned wheel bearing units also have the problem that during the roller riveting process, the inner ring is disadvantageously widened or cracks might be generated in this ring. To counteract the widening of the inner ring during the roller riveting process, so-called radially raised inner rings have been produced whose additional material in the form of rolling bearing steel contributes to the fact that the inner ring has an increased expansion stability. A disadvantage in the raised inner ring in that arrangement is that more installation space is used that is normally needed for the sensor arrangement for detecting the rotational speed.

From DE 11 2009 002 688 T5, a wheel bearing unit is known that has a radially raised inner ring that is resistant to deformation especially during the roller riveting process and is simultaneously covered on the vehicle side by a cover forming an inner contact on the outer ring. The cover here represents the only vehicle-side seal.

The sensor is also not easily integrated into the cover, because for replacing the sensor the cover cannot be opened without additional tools. Sensor integration into the cover also requires additional sealing.

### SUMMARY

The invention is based on the objective of providing a wheel bearing unit whose vehicle-side seal and sensor arrangement have no functional disadvantages but simultaneously exhibit the most optimum possible construction with respect to installation space. The deformation-resistant design of the inner ring is to be guaranteed at the same time.

The objective is achieved in a wheel bearing unit of the type noted above in that a signal emitter is arranged flat axially on the vehicle side on the raised area, wherein the movement of the signal emitter in the axial direction is accommodated by a cover and the cover has a protrusion for accommodating a sensor axially opposite the signal emitter.

The raised area can have different shapes, wherein, in the radial direction, the inner ring thickness is increased substantially in comparison to the thickness in the area of the rolling body raceway. The maximum outer diameter of the inner ring that is located in the raised area can here radially surpass the middle reference circle of the row of rolling bodies located on the inner ring. The middle reference circle of a row of rolling bodies is defined by the centers of the rolling bodies that are arranged in the row of rolling bodies and form, all together, a circle running through the centers of the rolling bodies.

Alternatively, the difference between the smallest outer radius of the inner ring and the largest outer radius of the inner ring can be a difference that corresponds essentially to the diameter of the rolling bodies. Advantageously, the raised area of the inner ring can form, together with the surface arranged radially opposite on the outer ring, a sealing gap or can at least radially narrow such that a lubricant retention function is guaranteed.

Ideally, the difference of the largest outer radius to the smallest inner radius of the inner ring corresponds essentially to the width of the inner ring. In this way, the middle radius of the inner ring can be displaced radially outward such that very good stability characteristics are produced for roller riveting.

The signal emitter can be, for example, an encoder or pulse wheel with different magnetic sections. The poles can be formed by magnets or alternatively from a material that can be magnetized at a later time. In this context it is important that the cover is made from a material that makes the movement of the magnetic fields detectable also through the cover. To this end, the cover must absorb as little magnetic energy as possible or no magnetic energy and therefore must not be magnetizable. Ideally, the cover is made from a plastic or a non-magnetizable metal.

The protrusion is arranged opposite the signal emitter, wherein this protrusion can also partially take over a holding function within the outer ring, but is mainly provided for accommodating the sensor. The protrusion can be formed accordingly. It is advantageous that the sensor can be mounted outside of the sealed space, but is nevertheless located in a protected position in which it cannot be shifted or damaged without additional means. In particular, the outer ring can now be used to protect the sensor advantageously in that the axial length of the outer ring is adapted accordingly. For classic motor vehicle applications, an extension in the millimeter range, between 2-6 mm, can result in optimal coverage for protecting the sensor. A very good compromise between axial construction width and optimum protection is an extension of the outer ring past the axially oriented vehicle-side surface of the inner ring by 4 mm.

In addition, the protrusion can be constructed such that the sensor can be positioned as close as possible to the signal emitter. In other words, the signal emitter forms the smallest possible gap with a ring-shaped part of the protrusion.

Advantageously, the cover is fixed on the outer ring and seals the wheel hub axially on the vehicle side. Advantageously the fastening options on the outer ring can vary, wherein the cover can be arranged in an interference fit on the outside on the outer ring or alternatively can contact the outer ring on the inside or can have a ring-shaped fastening area there. If it is an axially extended outer ring that projects past the end face of the inner ring by 2, 4, or even 6 mm, then a cover can be advantageously mounted on the inner side to be arranged close to the end side of the inner ring with a recessed protrusion that can be constructed, for example, as a groove. The proximity is defined in that the distance from the signal emitter to the sensor is selected sufficiently for the selected type of detection to guarantee reliable and correct transmission.

Advantageously, the protrusion is arranged essentially radially within the outer ring. This produces special protection for the sensor that can also be arranged at different positions still in the circumferential direction when the protrusion is constructed as a groove. In this way, the sensor can be optimized with respect to its size in agreement with the radial overlap by the outer ring. In other words, the smaller the sensor can be designed, the less rolling bearing steel must be used for the axial extension of the outer ring.

Advantageously, the protrusion has a ring-shaped design, but could also have a ring-shaped design only in some sections, wherein a fastening area can be defined for the sensor in the circumferential direction. In this way, the user can be directed at which point the sensor should be mounted. In particular, the protrusion can consider only the extent of the sensor, in order to simplify the insertion of the sensor, wherein the protrusion takes into account the outer dimensions of the sensor and maps this in a mating shape.

In one advantageous embodiment, the protrusion is formed for fastening the sensor. In this way, the protrusion takes over not only the optimum arrangement function and protective function, but can also fix the sensor in the circumferential direction and/or axial direction. For this purpose, a series of different measures can be used, wherein the fastening can involve a snap-on mechanism or can be based on a screw-in connection or clamping connection of the sensor in the protrusion.

Advantageously, for a ring-shaped protrusion, a locking ring can be fastened for holding the sensor in the recess. In this way, a locking ring can be provided especially for the fastening function that also supports, for example, a removal and re-attachment of the sensor in the protrusion. The locking ring can be attached, for example, in an interference fit in the protrusion, so that the locking ring advantageously contributes, together with the sensor, to automation during the assembly of the wheel bearing unit. The locking ring can be pressed into the protrusion in one processing step, namely together with the sensor, wherein this can even be performed before the fastening of the cover on the outer ring. Alternatively, it can be advantageous to bring the sensor into position only at a later time, during the installation of the wheel bearing unit in the vehicle. In this case it is advantageous to first press the locking ring onto the cover, then to set the cover on the wheel bearing unit, and to let the sensor snap into the locking ring, for example, during the installation of the wheel bearing unit.

In one advantageous embodiment, the raised area of the inner ring forms, together with the outer ring, a sealing gap in which, if necessary, a holding element of the signal emitter can be arranged. Although the main sealing function is taken over by the cover, the sealing gap between the outer ring and the inner ring can be advantageous on the raised area if it involves holding lubricant in the vicinity of the rolling bodies. For sealing, a holding element can also contribute, which further reduces the sealing gap radially and is actually provided for holding the signal emitter.

Advantageously, the signal emitter is bonded, pressed, or connected with a positive-locking fit onto the raised area of the inner ring. Preferably, the signal emitter can be mounted flat on the raised area, wherein the signal emitter runs in the axial or radial direction parallel to the fastening surface of the raised area. It could be that the signal emitter is placed on a holding plate that is arranged between the signal emitter and the fastening surface of the raised area. In every case, special stability of the signal emitter is provided by this construction, because it forms a flat contact on the very stable inner ring and is very resistant to undesired changes in position.

An adhesive bond is provided especially for a detection of movement in the axial direction, because the axial end side of the inner ring is designed for this. In contrast, an interference fit is more advantageous for an essentially cylindrical signal emitter, exactly like for a signal emitter, whose holding element or carrier has a cylindrical fastening area. A positive-locking fit produced, for example, by pins or cut groove, could also be advantageous.

In one advantageous embodiment, the cover is essentially surrounded by the outer ring. In this way, not only the sensor, but also the cover can be protected and must be protected not at all or at least less by its own material thickness, but instead can be designed thinner or more lightweight.

Additional advantageous constructions and preferred improvements of the invention can be found in the description of the figures and/or in the dependent claims.

### BRIEF DESCRIPTION OF THE DRAWINGS

The invention is described and explained in more detail below with reference to embodiments shown in the figures.

Shown are:

FIG. 1 a first wheel bearing unit with raised inner ring and a first inner cover, and

FIG. 2 a second wheel bearing unit with raised inner ring and with a second inner cover.

### DETAILED DESCRIPTION OF THE PREFERRED EMBODIMENTS

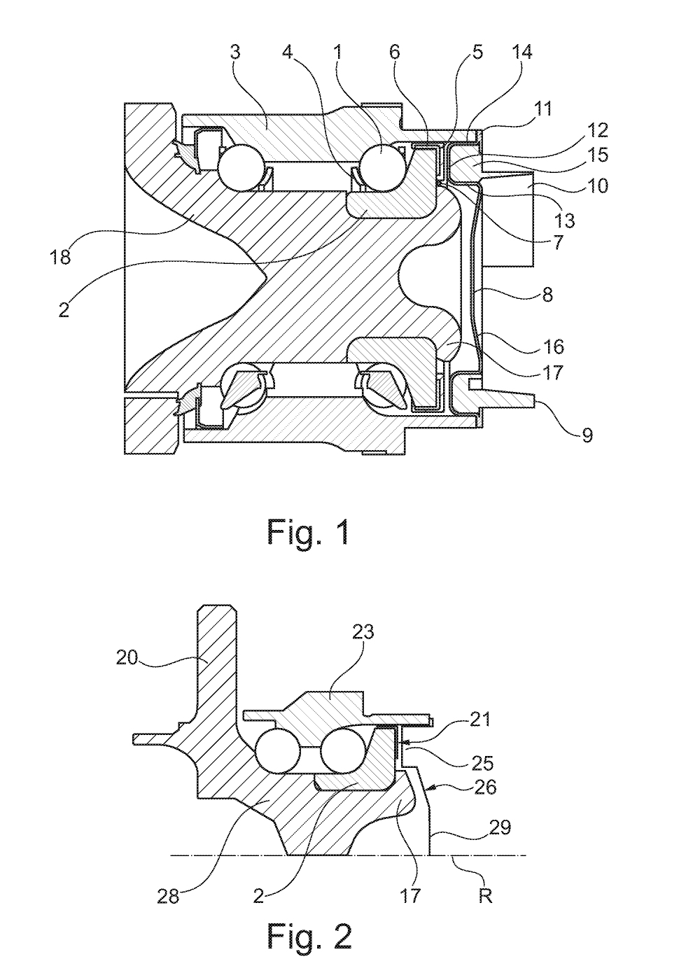

FIG. 1 shows a two-row angular contact ball bearing unit whose rows of rolling bodies 2 are pretensioned by means of the outer ring 3 in that the inner ring 2 is moved axially into position and pretensioned by means of the roller riveted connection 17.

The inner ring 2 has, on its raised area, an encoder 5 that can be read out in the axial direction and that acts as a signal emitter in this embodiment. The encoder 5 is mounted on a holding plate 6 in that a magnetizable powder is embedded in an elastomer. Advantageously, the elastomer surrounds the entire holding plate 6, wherein a static seal to the inner ring 2 is created on both sides.

The raised area of the inner ring 2 forms, together with the outer ring 3, a sealing gap in which the holding plate 6 coated with elastomer is arranged. In this way, lubricant remains in the rolling space, advantageously in the neighborhood of the cage 4.

Due to the raised area, the roller riveted connection 17 of the wheel bearing unit can be clearly shaped without a problem, wherein quicker riveting is also guaranteed. Here, the released forces can be outstandingly absorbed by the inner ring 2. The inner ring 2 can now act as a stable carrier for the holding plate 6 and also for the encoder 5.

It is also advantageous that the signal from the encoder 5 can be detected axially with a relatively large radius, wherein a large number of alternating north and south poles can be used and the precision of the rotational speed detection for an anti-lock braking system is improved.

In addition, it is advantageous for the sealing by the cover 8 that an elastic seal is guaranteed by the fold 11 that is further supported in that the protrusion 15 contacts the outer ring 3 radially on the inside.

The disk-shaped part 12 of the protrusion 15 can be guided axially very close to the encoder 5, wherein a good signal strength can be guaranteed. The ring-shaped section 13 of the cover 8 forms, in combination with the ring-shaped parts 12, 14, an essentially square or rectangular sectional surface of the ring-shaped protrusion 15. This cross-sectional surface permits the simple arrangement of sensors that can be inserted without additional tools axially into the protrusion 15 and radially within the outer ring 3.

The locking ring 10 is provided to fasten a sensor within the protrusion 15 in that auxiliary devices 9 are used to support the fastening. This can take place, for example, by a snap-on connection or clamping connection.

The raised area of the inner ring 2 can be seen essentially as the vehicle-side rim of the inner ring whose outer diameter is significantly increased in the direction of the outer ring 3. The outer diameter of the vehicle-side rim that is viewed as the largest outer diameter of the inner ring 2 is radially approximately at the height of the rolling contact between the row of rolling bodies 1 and the outer ring 3.

Advantageously, the protrusion 15 can also be constructed as a spring groove, wherein elasticity in the radial direction relative to the outer ring 3 is guaranteed. In this way, an excellent sealing effect of the cover 8 can be produced.

FIG. 2 shows another wheel bearing unit in cross section along the rotational axis R, wherein the cover 29 has, in the area of the roller riveted connection 17, a conical piece 26 that can then be advantageous if the fastening function does not have to be guaranteed within the protrusion 25, but instead the not-shown sensor is fixed in the wheel carrier or in another component outside of the wheel bearing unit.

In summary, the invention relates to a roller riveted wheel bearing unit whose inner ring 2 has a radially raised area in order to eliminate production problems in rolling riveting. For such a wheel bearing unit, the most optimum sensor arrangement possible, like that needed, for example, for detecting rotational speeds, is to be proposed without having to add disadvantages in the rotational speed detection, the sealing, or the strength optimization of the inner ring 2. An axially short construction was found that also implies a protected sensor in a cover 8. The sensor can be attached to a protrusion 15 that can be arranged partially or completely within the outer ring 3.

### LIST OF REFERENCE NUMBERS

1 Row of rolling bodies
2 Inner ring
3 Outer ring
4 Cage
5 Signal emitter, encoder
6 Retaining plate, retaining element
7 Sealing ring
8 Cover
9 Fastening device
10 Locking ring
11 Fold, axial spring
12 Ring-shaped partial section
13 Cylindrical partial section
14 Cylindrical partial section
15 Protrusion
16 Conical partial section
17 Roller riveted connection
18 Wheel hub
20 Wheel flange
21 Encoder, signal emitter
23 Outer ring
25 Protrusion
26 Conical partial section
28 Wheel hub
29 Cover
R Rotational axis

1. A wheel bearing unit comprising an inner ring that can rotate together with a wheel hub, the inner ring is mounted by a roller riveted connection on the wheel hub in order to pre-tension a row of rolling bodies relative to an outer ring, a raised area of the inner ring adjacent to the roller riveted connection is raised radially above an outer rolling body raceway of the inner ring, a signal emitter is arranged flat on the raised area axially on the vehicle side, and movement of the signal emitter is detected by a sensor axially opposite the signal emitter on a cover and the cover has a protrusion for accommodating the sensor.

2. The wheel bearing unit according to claim 1, wherein the cover is fixed on the outer ring and covers the wheel hub axially on the vehicle side.

3. The wheel bearing unit according to claim 2, wherein the protrusion is arranged essentially radially within the outer ring.

4. The wheel bearing unit according to claim 2, wherein the protrusion has a ring-shape.

5. The wheel bearing unit according to claim 2, wherein the protrusion has a ring shape at least in some sections.

6. The wheel bearing unit according to claim 1, wherein the protrusion is provided for fastening the sensor.

7. The wheel bearing unit according to claim 4, wherein a locking ring is fastened for holding the sensor in the recess.

8. The wheel bearing unit according to claim 1, wherein the raised area of the inner ring forms, together with the outer ring, a sealing gap in which a retaining element of the signal emitter is arranged.

9. The wheel bearing unit according to claim 1, wherein the signal emitter is bonded or pressed onto the raised area or connected with a positive fit to said raised area.

10. The wheel bearing unit according to claim 1, wherein the cover is essentially radially surrounded by the outer ring.
